(19) United States
(12) Patent Application Publication
(10) Pub. No.: US 2006/0231118 A1
(43) Pub. Date: Oct. 19, 2006

(54) Tape cleaning device and tape cleaning method

(75) Inventors: Tetsuyuki Narabaysahi, Tokyo (JP); Shinji Kunimoto, Tokyo (JP); Hiroyuki Atsuumi, Tokyo (JP)

Correspondence Address: THE WEBB LAW FIRM, P.C., 700 KOPPERS BUILDING, 436 SEVENTH AVENUE, PITTSBURGH, PA, 15219, US

(73) Assignee: Mitsui Mining and Smelting Co., Ltd., Shinagawa-ku (JP)

(21) Appl. No.: 11/361,856

(22) Filed: Feb. 24, 2006

(30) Foreign Application Priority Data
Feb. 25, 2005 (JP) 2005-051866

(51) Int. Cl. B08B 3/12; B08B 3/00; B08B 7/00

(52) U.S. Cl. 134/1; 134/184; 134/198; 134/34; 134/33

(57) ABSTRACT

Disclosed is a tape cleaning device and tape cleaning method which can improve tape cleaning efficiency. The tape cleaning device includes a cleaning section structured in such a way so as to hold dipping water in a dipping tank, in which second and third guide rollers are dipped to dip the tape being transferred. The dipping tank holds an ultrasonic cleaning means which faces a fourth guide roller.

### BACKGROUND OF THE INVENTION

1. Field of the Invention

The present invention relates to a tape cleaning device which cleans film carrier tapes for mounting electronic devices, e.g., TAB and COF tapes, and to a tape-shaped member cleaning method.

2. Description of the Related Art

Recently, film carrier tapes for mounting electronic devices, e.g., TAB and COF tapes for flat panel displays and printers have been known.

These film carrier tapes for mounting electronic devices may be contaminated with foreign matter attached thereon, e.g., dust floating in air, or debris generated by friction with a reel or metallic debris from a device with which they come into contact while being produced or examined. The foreign matter attached on the tape should be removed, because it may cause problems, e.g., short circuit of a printed wiring board.

One of the tape cleaning devices proposed so far flatters the tape being transferred with ultrasonic waves while it is dipped in a solution held in a cleaning tank (Patent Document 1).

[Patent Document 1] JP-A 2003-24888

However, a conventional cleaning device involves problems resulting from foreign matter remaining in a solution after it is ultrasonically removed from the tape. The foreign matter once removed from the tape may again contaminate the tape to deteriorate cleaning efficiency.

The present invention has been developed to solve the problems involved in the conventional devices. It is an object of the present invention to provide a tape cleaning device which can improve tape cleaning efficiency. It is another object to provide a tape cleaning method.

### SUMMARY OF THE INVENTION

The inventors of the present invention have adopted, after having extensively studied to solve the above problems, the following tape cleaning device and tape cleaning method.

Tape Cleaning Device of The Present Invention:

The tape cleaning device of the present invention comprises transferring means for transferring a tape, a dipping tank holding a solution in which the tape being transferred is dipped, and ultrasonic cleaning means for removing foreign matter attached on the tape by spraying an ultrasonically vibrating solution onto the tape after the tape is dipped in the tank.

The above structure swells foreign matter attached on the tape, while the tape is being dipped, to weaken its adherence to the tape. Moreover, it can prevent redeposition of the removed foreign matter on the material, because it is removed from the material after it is dipped in the tank.

Moreover, the tape transferring means of the tape cleaning device of the present invention comprises supporting means on a transferring line for supporting the tape at a position at which a solution is sprayed onto the material by the ultrasonic cleaning means.

The above structure supports the tape being cleaned with the ultrasonically vibrating solution to prevent it from being flattered, to facilitate removal of the foreign matter attached on the material.

Still more, the tape cleaning device of the present invention also comprises pre-cleaning means for removing foreign matter attached on the tape before the tape is cleaned by the ultrasonic cleaning means and after the tape is dipped in the tank.

The above structure can further facilitate removal of foreign matter attached on the tape, because it reduces quantity of the foreign matter to be removed by the ultrasonic cleaning means.

Still more, the tape transferring means of the tape cleaning device of the present invention also comprises a plurality of guiding means for guiding upwards the tape after the tape is dipped in the tank, and the pre-cleaning means is structured in such a way to remove foreign matter attached on the tape guided upwards by the plurality of guiding means.

The above structure can secure a longer cleaning path for the cleaning device than in a device in which the dipped tape is transferred in a horizontal direction, to further facilitate removal of foreign matter attached on the tape, because it further reduces quantity of the foreign matter to be removed by the ultrasonic cleaning means.

Still more, the tape cleaning device of the present invention preferably sets the tape at a tilt angle of 10 to 170° while the tape is being guided upwards by the plurality of guiding means.

A tilt angle below 10 or above 170° is not desirable, because the tape cleaning path for the pre-cleaning means is essentially the same as the horizontal path and hence foreign matter removing efficiency is essentially unchanged.

Still more, the tape transferring means of the tape cleaning device of the present invention comprises a plurality of guiding means for guiding in a horizontal direction the tape after the tape is dipped in the tank, and the pre-cleaning means is structured in such a way to remove foreign matter attached on the tape guided in a horizontal direction by the plurality of guiding means.

The above device structure can keep the device lower than a structure in which the tape is guided upwards after it is dipped in the tank.

Still more, the tape transferring means of the tape cleaning device of the present invention is structured in such a way that some of the guiding means on the ultrasonic cleaning means side work also as the supporting means and, at the same time, the ultrasonic cleaning means is configured so that the solution is sprayed onto the tape supported on the transferring line by the guiding means.

The above device structure can reduce number of required device members.

Still more, the tape cleaning device of the present invention also comprises post-cleaning means for removing foreign matter attached on the tape after the tape is dipped in the tank and cleaned by the ultrasonic cleaning means.

The above device structure can remove foreign matter if it remains on the tape after it is cleaned by the ultrasonic cleaning means.

Still more, the tape cleaning device of the present invention also comprises drying means for drying the tape after the tape is cleaned by the ultrasonic cleaning means or post-cleaning means.

The above device structure can dry the cleaned tape in a shorter time than a device in which cleaning and drying of the tape are separately conducted.

Still more, the tape cleaning device of the present invention also comprises draining means upstream of the drying means for removing the solution from the cleaned tape.

The above device structure can reduce quantity of the solution remaining on the tape to be dried and hence drying time.

Still more, the tape transferring means of the tape cleaning device of the present invention, which sets a spacer tape on the tape to be cleaned, comprises tape supplying means and tape receiving means, the former for sending the tape to the transferring line while separating the spacer tape from the tape and the latter for receiving the tape cleaned and dried by the drying means while setting another spacer tape thereon.

The above structure can smoothly perform separation of the spacer tape from the tape at rewinding position, the spacer tape preventing from damages of the cleaned tape surface (e.g., wiring pattern on the tape surface) at winding position.

Still more, the tape cleaning device of the present invention also comprises a dust-free packing chamber for packing, in a dust-free condition, the cleaned tape contained in the tape receiving means.

The above structure can prevent foreign matter from being attached on the cleaned and dried tape while it is being packed.

Still more, the tape cleaning device of the present invention cleans the tape which is used as a film carrier tape for mounting electronic devices, to remove foreign matter attached on the film carrier tape.

The above structure can produce the same functions for the film carrier tape for mounting electronic devices as the one for cleaning the tape described above.

Tape Cleaning Method of the Present Invention:

The tape cleaning method of the present invention for cleaning the tape being transferred comprises steps for dipping the tape, and for ultrasonic cleaning which removes foreign matter attached on the tape by spraying an ultrasonically vibrating solution onto the tape after it is dipped.

The above structure swells foreign matter attached on the tape in the dipping step, to weaken its adherence to the tape. Moreover, it can prevent redeposition of the removed foreign matter on the material, because it cleans the tape with ultrasonic waves after it is treated in the dipping step.

The tape cleaning method of the present invention also sprays the solution onto the tape while it is supported on a spraying position set on a transferring line in the ultrasonic cleaning step.

The above structure can facilitate removal of foreign matter attached on the tape, because it prevents flatter of the tape being cleaned with the ultrasonically vibrating solution.

Still more, the tape cleaning method of the present invention also comprises a pre-cleaning step upstream of the ultrasonic cleaning step for removing foreign matter attached on the dipped tape.

The above structure can further facilitate removal of foreign matter attached on the tape, because it reduces quantity of the foreign matter to be removed in the ultrasonic cleaning step.

Still more, the tape cleaning method of the present invention transfers upwards the dipped tape in the pre-cleaning step.

The above structure can secure a longer cleaning path for the pre-cleaning step than in a step in which the dipped tape is transferred in a horizontal direction, to further facilitate removal of foreign matter attached on the tape, because it further reduces quantity of the foreign matter to be removed in the ultrasonic cleaning step.

Still more, the tape cleaning method of the present invention preferably sets the tape at a tilt angle of 10 to 170° while the tape is being transferred upwards in the pre-cleaning step.

A tilt angle below 10 or above 170° is not desirable, because the tape cleaning path for the pre-cleaning step is essentially the same as the horizontal path and hence foreign matter removing efficiency is essentially unchanged.

Still more, the tape cleaning method of the present invention transfers the dipped tape in a horizontal direction in the pre-cleaning step.

The above structure can keep height of the transferring region lower than a structure in which the dipped tape is transferred upwards.

Still more, the tape cleaning method of the present invention also comprises a post-cleaning step downstream of the ultrasonic cleaning step for removing foreign matter attached on the tape.

The above structure can remove foreign matter if it remains on the tape after it is cleaned in the ultrasonic cleaning step.

Still more, the tape cleaning method of the present invention also comprises a drying step downstream of the ultrasonic cleaning or post-cleaning step for drying the cleaned tape.

The above structure can clean and dry the tape in a shorter time than a structure in which cleaning and drying of the tape are separately conducted.

Still more, the tape cleaning method of the present invention also comprises a draining step upstream of the drying step for removing the solution from the cleaned tape.

The above structure can reduce quantity of the solution remaining on the tape to be dried and hence drying time.

Still more, the tape cleaning method of the present invention, which cleans the tape on which a spacer tape is set, also comprises a tape supplying step upstream of the dipping step for sending the tape to the transferring line after separating the spacer tape from the tape and tape receiving step downstream of the drying step for receiving the cleaned and dried tape while setting another spacer tape thereon.

The above structure can smoothly perform separation of the spacer tape from the tape at rewinding position, the spacer tape preventing from damages of the cleaned tape surface (e.g., wiring pattern on the tape surface) at winding position.

Still more, the tape cleaning method of the present invention also comprises a dust-free packing step downstream of the tape receiving step for packing, in a dust-free condition, the received tape.

The above structure can prevent foreign matter from being attached on the cleaned and dried tape while it is being packed.

Still more, the tape cleaning method of the present invention cleans the tape which is used as a film carrier tape for mounting electronic devices, and to remove foreign matter attached on the film carrier tape.

The above structure can produce the same functions for the film carrier tape for mounting electronic devices as the one for cleaning the tape described above.

Effect of the Invention

The tape cleaning device of the present invention dips the tape in a liquid (pure water or a mixture of pure water and a detergent), to weaken adherence of foreign matter attached on the tape, because it swells or absorbs water. This can facilitate removal of the foreign matter attached on the tape by the ultrasonic cleaning means. Moreover, it can prevent redeposition of the removed foreign matter on the tape, because it is removed from the tape after it is dipped in the tank, and hence improve tape cleaning efficiency.

Moreover, the tape cleaning device of the present invention is also structured to prevent the tape from being flattered by supporting means, even when it is sprayed with an ultrasonically vibrating solution. This can further facilitate removal of foreign matter attached on the tape, and hence improve tape cleaning efficiency.

Still more, the tape cleaning device of the present invention also removes foreign matter beforehand by the pre-cleaning means to reduce quantity of the foreign matter to be removed subsequently by the ultrasonic cleaning means. This can further facilitate removal of foreign matter attached on the tape, and hence improve tape cleaning efficiency.

Still more, the tape cleaning device of the present invention transfers the dipped tape upwards by a plurality of guiding means to secure a longer cleaning path for the pre-cleaning means than in a device in which the dipped tape is transferred in a horizontal direction. This can further reduce quantity of the foreign matter to be removed by the ultrasonic cleaning means, and hence facilitate removal of foreign matter attached on the tape and improve tape cleaning efficiency.

Still more, the tape cleaning device of the present invention sets the tape at a tilt angle of 10 to 170° while it is transferred upwards. This can secure a longer cleaning path for the pre-cleaning means than in a device in which the tape is transferred in a horizontal direction, and hence securely improve tape cleaning efficiency.

Still more, the tape cleaning device of the present invention transfers the dipped tape in a horizontal direction by a plurality of guiding means to keep height of the device lower than a device one in which the tape is guided upwards. This can reduce space for setting the device.

Still more, the tape transferring device of the present invention is structured in such a way that some of the guiding means on the ultrasonic cleaning means side work also as the supporting means to reduce number of required device members. This can reduce the production cost while improving tape cleaning efficiency.

Still more, the tape cleaning device of the present invention is also structured in such a way to remove foreign matter, even when it remains on the tape cleaned by the ultrasonic cleaning means, by the post-cleaning means. This can further improve tape cleaning efficiency.

Still more, the tape cleaning device of the present invention is also structured in such a way to perform cleaning and drying the tape in the same device. This can clean and dry the tape in a shorter time than a device in which cleaning and drying of the tape are separately conducted, and hence improve tape production efficiency.

Still more, the tape cleaning device of the present invention removes the solution from the cleaned tape by the draining means upstream of the drying means to reduce quantity of the solution to be removed in the drying step. This reduces the drying time and therefore further reduces the time required from the cleaning to the drying of the tape. This can further improve tape production efficiency.

Still more, the tape cleaning device of the present invention separates a spacer tape from the tape being supplied, and receives the cleaned tape while setting another spacer tape thereon. This structure can smoothly perform separation of the spacer tape from the tape while preventing damages of the cleaned tape surface (e.g., wiring pattern on the tape surface), and hence improve production efficiency of the tape on which the spacer tape is set.

Still more, the tape cleaning device of the present invention also comprises the dust-free packing chamber for packing, to prevent foreign matter from being attached on the cleaned and dried tape while it is being packed. This can improve tape quality.

Still more, the tape cleaning device of the present invention is also structured in such a way to clean the tape which is used as a film carrier tape for mounting electronic devices. This can produce the same functions for the film carrier tape for mounting electronic devices as the one for cleaning the tape described above.

The tape cleaning method of the present invention dips the tape in a liquid (pure water or a mixture of pure water and a detergent) to weaken adherence of foreign matter attached on the tape, because it swells or absorb water. This can facilitate removal of the foreign matter attached on the tape in the ultrasonic cleaning step. Moreover, it can prevent redeposition of the removed foreign matter on the material, because it is removed from the material after it is dipped in the tank, and hence improve tape cleaning efficiency.

Moreover, the tape cleaning method of the present invention prevents the tape from being flattered, even when it is sprayed with a solution in the ultrasonic cleaning step. This can further facilitate removal of foreign matter attached on the tape, and hence improve tape cleaning efficiency.

Still more, the tape cleaning method of the present invention also removes foreign matter beforehand by the pre-cleaning step to reduce quantity of the foreign matter to be removed subsequently in the ultrasonic cleaning step. This can further facilitate removal of foreign matter attached on the tape, and hence improve tape cleaning efficiency.

Still more, the tape cleaning method of the present invention transfers the dipped tape upwards to secure a longer cleaning path for the pre-cleaning step than in a method in which the dipped tape is transferred in a horizontal direction. This can further reduce quantity of the foreign matter to be removed by the ultrasonic cleaning means, and hence facilitate removal of foreign matter attached on the tape and improve tape cleaning efficiency.

Still more, the tape cleaning method of the present invention sets the tape at a tilt angle of 10 to 170° while it is transferred upwards. This can secure a longer cleaning path for the pre-cleaning step than in the one in which the tape is transferred in a horizontal direction, and hence securely improve tape cleaning efficiency.

Still more, the tape cleaning method of the present invention transfers the dipped tape in a horizontal direction to keep height of the transferring region lower than in a method in which the tape is transferred upwards. This can reduce space of the transferring region.

Still more, the tape cleaning method of the present invention is also structured in such a way to remove foreign matter, even when it remains on the tape cleaned in the ultrasonic cleaning step, in the post-cleaning step. This can further improve tape cleaning efficiency.

Still more, the tape cleaning method of the present invention is also structured in such a way to continue the drying step from the cleaning step. This can clean and dry the tape in a shorter time than a method in which cleaning and drying of the tape are separately conducted, and hence improve tape production efficiency.

Still more, the tape cleaning method of the present invention removes the solution from the cleaned tape in the draining step upstream of the drying step to reduce quantity of the solution to be removed in the drying step. This reduces the drying time and therefore further reduces the time required from the cleaning to the drying of the tape. This can further improve tape production efficiency.

Still more, the tape cleaning method of the present invention separates a spacer tape from the tape being supplied, and receives the cleaned tape while setting another spacer tape thereon. This can smoothly perform separation of the spacer tape from the tape while preventing damages of the cleaned tape surface (e.g., wiring pattern on the tape surface), and hence improve production efficiency of the tape on which the spacer tape is set.

Still more, the tape cleaning method of the present invention includes the dust-free packing step, to prevent foreign matter from being attached on the cleaned and dried tape while it is being packed. This can improve tape quality.

Still more, the tape cleaning method of the present invention is also structured in such a way to clean the tape which is used as a film carrier tape for mounting electronic devices. This can produce the same functions for the film carrier tape for mounting electronic devices as the one for cleaning the tape described above.

### BRIEF DESCRIPTION OF THE DRAWINGS

FIG. 1 schematically illustrates the tape cleaning device of the first embodiment of the present invention;

FIG. 2 is a plan view of the tape cleaning device of the first embodiment;

FIG. 3 is an enlarged figure illustrating the essential portion of the tape cleaning device illustrated in FIG. 1;

FIG. 4 schematically illustrates the essential portion of the tape cleaning device of the second embodiment of the present invention;

FIG. 5 schematically illustrates the essential portion of the tape cleaning device of the third embodiment of the present invention; and

FIG. 6 schematically illustrates the essential portion of the tape cleaning device of the fourth embodiment of the present invention.

### DETAILED DESCRIPTION OF THE PREFERRED EMBODIMENTS

The embodiments of the present invention are described by referring to the attached drawings.

### First Embodiment

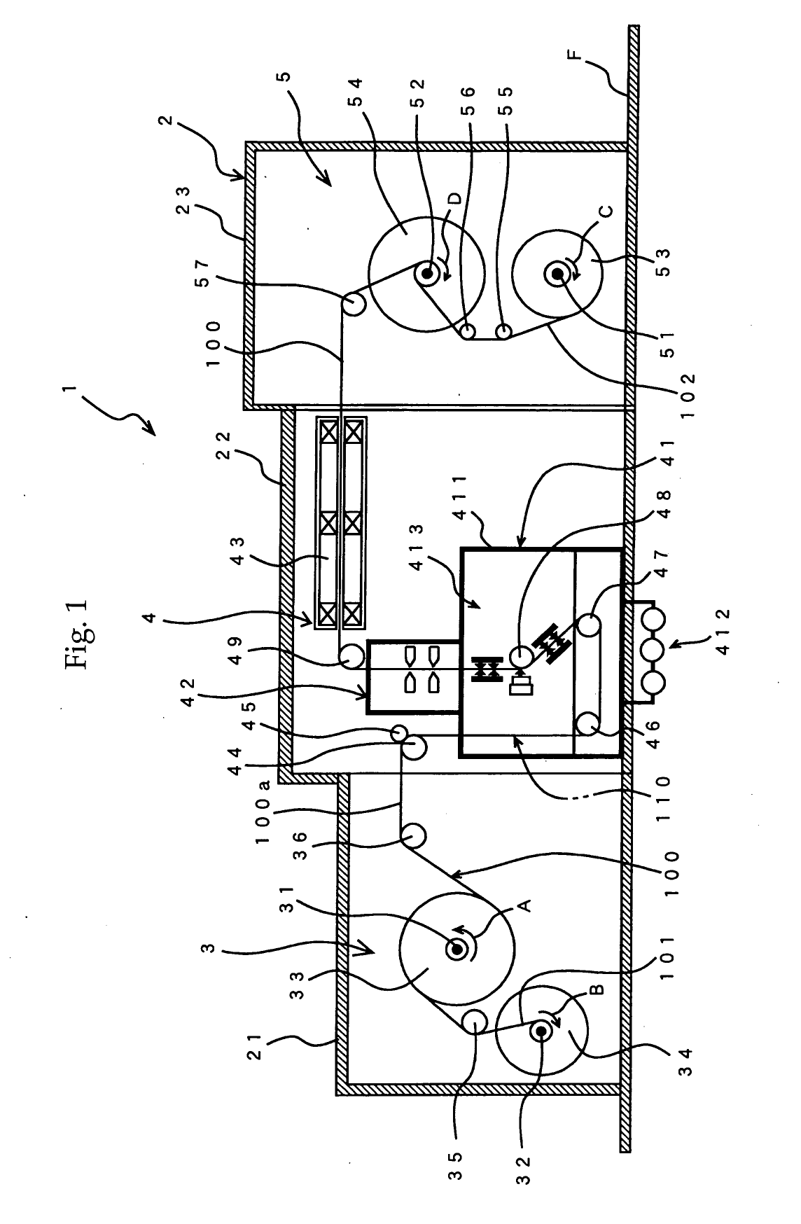

FIG. 1 schematically illustrates the tape cleaning device 1 of the first embodiment of the present invention. It is for cleaning the film carrier tape for mounting film carrier tape 100. In this embodiment, the film carrier tape for mounting film carrier tape 100 is hereinafter referred to as the tape 100.

The tape cleaning device 1, totally set in the clean room R, comprises the clean booth 2 set on the floor F in the clean room R. The clean booth 2 contains the tape supplying means 3, tape cleaning means 4 and tape receiving means 5, which are set in a line on the floor F. The tape cleaning device 1 also comprises a controller (not shown), also set on the floor F but outside of the clean booth 2. The clean booth 2 may be omitted. In this case, the tape supplying means 3, tape cleaning means 4, tape receiving means 5 and controller constituting the tape cleaning device 1 are directly set in the clean room R.

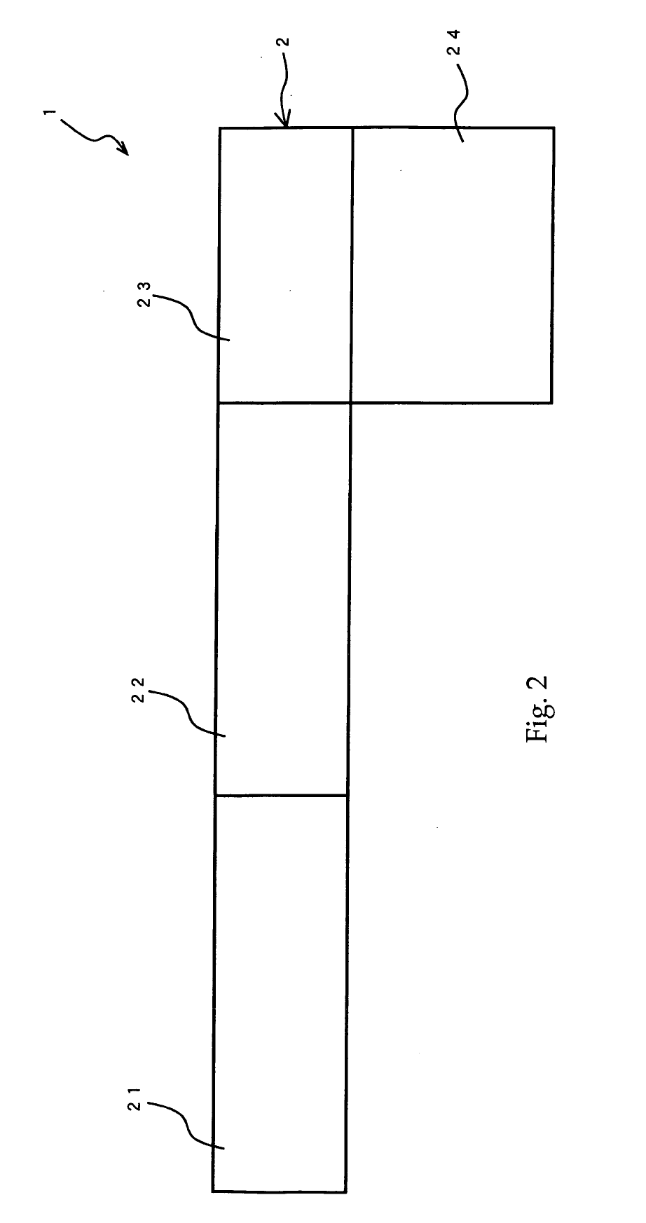

Referring to FIG. 2, the clean booth 2 comprises the three booths 21 to 23 set in a line, and also packing booth 24 set next to the end booth 23.

The three booths 21 to 23 are formed in such a way that the tape supplying means 3, tape cleaning means 4 and tape receiving means 5 are each set separately in each booth. The booth 21 containing the tape supplying means 3 is structured in such a way that one side can be opened to allow an operator to set the tape 100, for example.

The packing booth 24 has a sufficient space for packing the cleaned tape 100 by an operator, and is structured in such a way that one side can be opened for an operator to go into the booth. Moreover, the packing booth 24 has a higher dust-free function than the booths 21 to 23.

The tape supplying means 3 sends the tape 100 to the tape cleaning means 4, where it is to be cleaned. The tape supplying means 3 comprises a supporter (not shown) set on the floor F in the booth 21, tape supplying reel 33 set over the supporter in a detachable manner via the rotational axis 31, spacer tape winding reel 34 set under the supporter in a detachable manner via the another rotational axis 32, two guide rollers 35 and 36 set over the supporter, and driving means (not shown) connected to each of the rotational axes 31 and 32.

The tape supplying reel 33 is supported by the supporter in such a way to freely rotate around the rotational axis 31. It supports the tape 100, to which a dummy tape (not shown) is connected to the end side of the tape, and spacer tape 101 set on the wiring-patterned surface 100a of the tape 100, both wound around the reel 33.

The spacer tape winding reel 34 is supported by the supporter in such a way to freely rotate around the rotational axis 32. The reel 34 is structured in such a way to wind the spacer tape 101 from the tape supplying reel 33. It supports no tape before the cleaning step starts.

The plurality of guide rollers 35 and 36 are set over the supporter, the former between the reels 33 and 34 for the spacer tape, and the latter between the tape supplying reel 33 and tape cleaning means 4 for supplying the tape.

The guide roller 35 is structured in such a way to guide the spacer tape 101 from the tape supplying reel 33 towards the spacer tape winding reel 34 while giving a tension to the tape.

The guide roller 36 is structured in such a way to guide the tape 100 from the tape supplying reel 33 towards the tape cleaning means 4 while giving a tension to the tape.

The driving means is structured in such a way to rotate the upper rotational axis 31 in the tape 100 supplying direction A, driving the tape supplying reel 33 to send the tape 100 to the tape cleaning means 4.

The driving means is also structured in such a way to rotate the lower rotational axis 32 in the spacer tape 101 winding direction B opposite to the direction A, driving the tape supplying reel 34 to separate and wind the spacer tape 101 from the tape supplying reel 33.

The tape cleaning means 4 cleans, drains and dries the tape 100 sent from the tape supplying means 3. It comprises the cleaning section 41 set on the floor F in the booth 22, air blow section 42 set on the section 41, hot-wind heater 43 as drying means for the present invention, set next to the section 42 in the booth 22, and the plurality of guide rollers 44 to 49 arranged in an almost U shape, all contained in the booth 22.

The plurality of guide rollers 44 to 49 are a pair of the first guide rollers 44 and 45 set near the air blow section 42 on the tape supplying means 3 side, second guide roller 46 set under the guide rollers 44 and 45 in the lower part of the cleaning section 41, third guide roller 47 set on a level with the guide roller 46 on the tape receiving means side, fourth guide roller 48 set obliquely upwards on the tape supplying means 3 side from the third guide roller 47 in the cleaning section 41, and fifth guide roller 49 set over the guide roller 48 and next to the air blow section 42.

The first guide rollers 44 and 45 are structured in such a way to guide the tape 100 sent from the guide roller 36, responsible for supplying the tape, to the second guide roller 46 below while holding the tape in-between.

The second guide roller 46 is structured in such a way to guide the tape 100 sent from the first guide rollers 44 and 45 in a horizontal direction to the third guide roller 47.

The third guide roller 47 is structured in such a way to guide the tape 100 sent from the second guide roller 46 obliquely upwards to the fourth guide roller 48.

The fourth guide roller 48 is structured in such a way to guide the tape 100 sent from the third guide roller 47 obliquely upwards to the fifth guide roller 49.

The fifth guide roller 49 is structured in such a way to guide the tape 100 sent from the fourth guide roller 48 in a horizontal direction to the tape receiving means 5.

The cleaning section 41 comprises the dipping tank 411 set on the floor F, recycling system 412 connected to the dipping tank 411, and cleaning section body 413 set in the dipping tank 411.

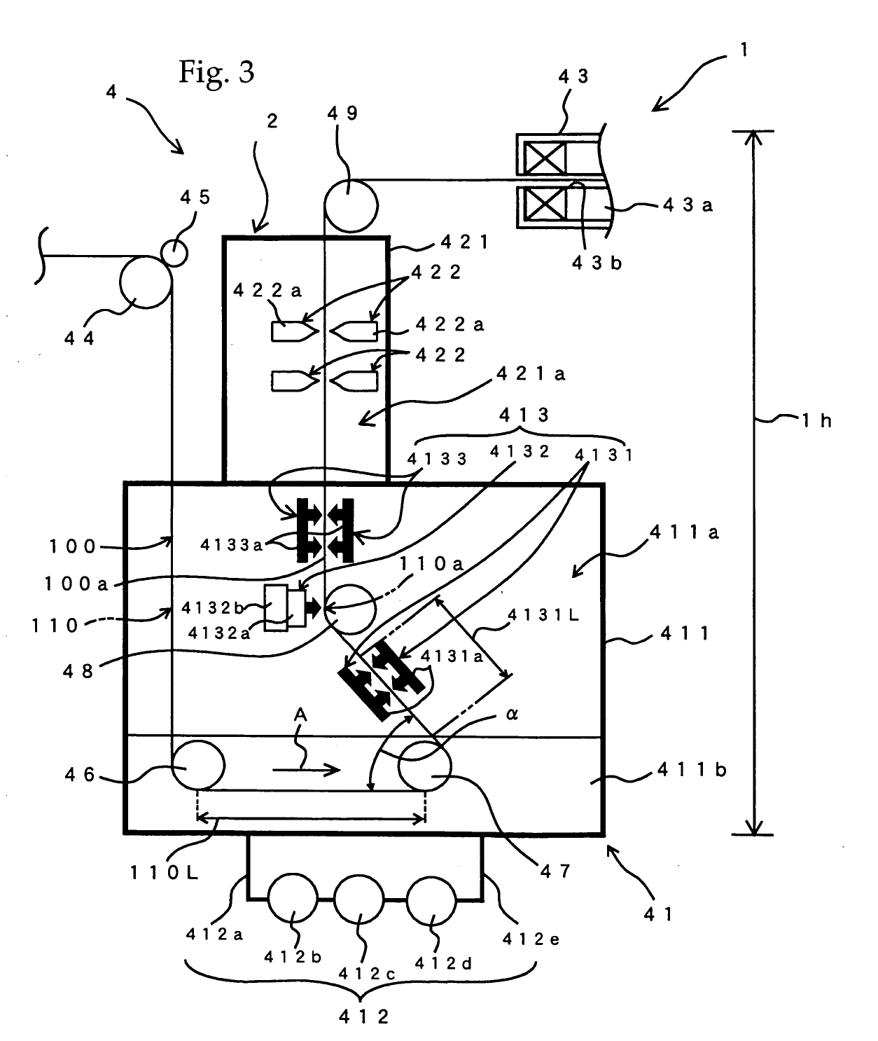

In the dipping tank 411, the receiving space 411a is formed as illustrated in FIG. 3. The dipping tank 411 has two openings (not shown) through which the tape 100 is passed on the tape supplying means 3 side and the air blow section 42 side.

The receiving space 411a holds the dipping water 411b to immerse the second and third guide rollers 46 and 47, to dip the tape 100 being transferred. The dipping water 411b may be pure water or a mixture of pure water and a detergent. It may be altered as required depending on type of the tape 100.

The dipping tank 411 is also provided with a water discharge and supply ports (not shown) on the basal plane, to which the recycling system 412 is connected.

The recycling system 412 comprises the pump 412b connected to the water discharge port in the dipping tank 411 via the water drainage pipe 412a, filter 412c connected to the discharge side of the pump 412b, and sterilization means 412d connected to the discharge side of the filter 412c, where the discharge side of the sterilization means 412d is connected to the water supply port of the dipping tank 411 via the water supply pipe 412e.

The recycling system 412 recycles the dipping water 411b back to the dipping tank 411 after sacking the water 411b from the tank 411 by the pump 412b, and then passing it through the filter 412c to remove foreign matter, e.g., dust, and sterilization means 412d for sterilization.

On the other hand, the cleaning section body 413 comprises a pair of the pre-cleaning means 4131, 4131 held between the third and fourth guide rollers 47 and 48, ultrasonic cleaning means 4132 set in such a way to face the fourth guide roller 48, and a pair of the post-cleaning means 4133, 4133 set over the fourth guide roller 48.

The pre-cleaning means 4131, 4131 are set to hold in-between the tape 100 passing between the third and fourth guide rollers 47 and 48, and comprise a tank (not shown) which holds a solution and the nozzle 4131a, connected to the tank, through which the solution is sprayed onto both sides of the tape 100.

The ultrasonic cleaning means 4132 comprises a tank (not shown) which holds a solution, the nozzle 4132a, connected to the tank, through which the film state solution is sprayed onto the wiring-patterned surface 100a of the tape 100, vibrator plate 4132b for ultrasonically vibrating the solution, and ultrasonic transmitter (not shown) for ultrasonically vibrating the vibrator plate 4132b.

The post-cleaning means 4133, 4133 are set to face each other to hold in-between the tape 100 leaving the fourth guide roller 48, and comprise a tank (not shown) which holds a solution and the nozzle 4133a, connected to the tank, through which the solution is sprayed onto both sides of the tape 100.

On the other hand, the air blow section 42 comprises the receiving section 421 set on the dipping tank 411, and two pairs of the air knives 422, 422 set in the receiving section 421 as the draining means for the present invention.

The receiving section 421 with the receiving space 421a has two openings (not shown) on the top and bottom, one is facing to the dipping tank 411 to pass the tape 100.

On the other hand, the air knives 422, 422 are set to face each other to hold the tape 100 in-between, comprising a tank (not shown) which holds compressed air and the nozzle 422a, connected to the tank, through which air is blown onto both sides of the tape 100.

The hot-wind heater 43 is separated into two parts, facing each other to hold in-between the tape 100 leaving the fifth guide roller 49. It comprises the hot-wind heater bodies 43a and ports 43b through which hot wind is blown onto both sides of the tape 100.

On the other hand, the tape receiving means 5 receives the tape 100 leaving the cleaning, draining and drying means, as illustrated in FIG. 1. It comprises a supporter (not shown) set on the floor F in the booth 23, spacer tape supplying reel 53 set under the supporter in a detachable manner via the rotational axis 51, tape winding reel 54 set over the supporter in a detachable manner via the another rotational axis 52, the plurality of guide rollers 55 to 57 set over the supporter, and driving means (not shown) connected to each of the rotational axes 51 and 52.

The spacer tape 102 in supplying reel 53 which is supported by the supporter in such a way to freely rotate around the rotational axis 51 is quite different from the spacer tape 101 in winding reel 32 in cleanliness because it is used for winding finished tape.

The tape winding reel 54 is supported by the supporter in such a way to freely rotate. It is structured in such a way to wind the tape 100 dried by the hot-wind heater 43 and spacer tape 101 sent from the spacer tape winding reel 53, setting the spacer tape 101 on the tape 100. It supports no tape before the cleaning step starts.

The plurality of guide rollers 55 to 57 contains guide roller 55 for the spacer tape 102, guide roller 56 for the spacer tape 102 together and guide roller 57 for the finished tape 100.

The guide roller 55 for supplying the spacer tape 102 is structured in such a way to guide the spacer tape 102 from the spacer tape supplying reel 53 towards the guide roller 56 for winding the spacer tape 102 while giving a tension to the spacer tape.

The guide roller 56 for winding the spacer tape 102 is structured in such a way to guide the spacer tape 102 from the guide roller 55 for supplying the spacer tape towards the tape winding reel 54 while further giving a tension to the spacer tape.

The guide roller 57 for winding the tape 100 is structured in such a way to guide the tape 100 dried by the hot-wind heater 43 towards the tape winding reel 54 while giving a tension to the tape 100.

The driving means is structured in such a way to rotate the lower rotational axis 51 in the spacer tape 102 supply direction C, driving the spacer tape supplying reel 53 to send the spacer tape 102 to the tape winding reel 54.

The driving means is also structured in such a way to rotate the upper rotational axis 52 in the tape 100 and spacer tape 102 winding direction D, driving the tape winding reel 54 to set and wind the tape 100 on the spacer tape 101 wound around the spacer tape supplying reel 53.

The guide roller 57 for winding the tape constitutes the tape 100 transferring line 110 together with the guide roller 36 for supplying the tape and the plurality of guide rollers 44 to 49 in the booth 22.

The transferring line 110 is arranged in an almost U shape in the booth 22, transferring the tape 100 from the third guide roller 47 to the fourth guide roller 38 obliquely upwards at a tilt angle α set at 45° (refer to FIG. 3).

These guide rollers 36, 44 to 49 and 57 constitute the tape 100 transferring line together with driving means for the tape supplying means 3 and for the tape receiving means 5, and reels 33 and 34 for the means 3 and reels 53 and 54 for the means 5.

The controller is connected to the driving means for the tape supplying means 3, driving means for the tape receiving means 5, recycling system 412, cleaning section body 413, air knives 422, 422, hot-wind heater 43, and so on to control them.

Next, the tape 100 cleaning method with the tape cleaning device of the above structure is described. First, an operator withdraws the tape 100 and spacer tape 101 from the tape supplying reel 33, and supports the spacer tape 101 end on the spacer tape winding reel 34.

An end of dummy tape (not shown) is connected to one end of the withdrawn tape 100. The dummy tape is passed over the guide rollers 36, 44, 45, 46 to 49 and 57, in this order. Then, the spacer tape 102 is withdrawn from the spacer tape supplying reel 53, and passed over the guide rollers 55 and 56 towards the tape winding reel 54, where the tape 100 is set on the dummy tape.

Then, the controller is switched on to activate the driving means for the tape supplying means 3 and tape receiving means 5, and to transfer the tape 100 in the transfer direction A. At the same time, the controller activates each of the connected means and device, to carry out the following steps in the order described.

Supplying Step:

The tape supplying reel 33 rotates in the supplying direction A to send the tape 100 to the transferring line 110 via the guide roller 36 for supplying the tape. At the same time, the spacer tape winding reel 34 rotates in the winding direction B to separate the spacer tape 101 from the tape 100, sending the spacer tape 101 to the spacer tape winding reel 34 via the guide roller 35 for winding the spacer tape.

Dipping Step:

The tape 100, put on the transferring line 110 via the tape supplying means 3, is transferred downwards by the first guide rollers 44 and 45 into the dipping water 411b held in the dipping tank 411, deflected by the second guide roller 46 to the tape receiving means 5 side, and then transferred in a horizontal direction to the third guide roller 47 while being dipped in the dipping water 411b, as illustrated in FIG. 3.

Pre-Cleaning Step:

The transferred tape 100 is deflected by the third guide roller 47 to the tape supplying means 3 side, and then transferred obliquely upwards by the fourth guide roller 48. A solution is sprayed by the pre-cleaning means 4131, 4131 onto both sides of the tape 100 being transferred.

Ultrasonic Cleaning Step:

A solution is sprayed by the ultrasonic cleaning means 4132 onto the wiring-patterned surface 100a of the tape 100 transferred, while being supported by the fourth guide roller 48.

Post-Cleaning Step:

The tape 100 passing the ultrasonic cleaning means 4132 is transferred upwards to the guide roller 49. At the same time, a solution is sprayed by the post-cleaning means 4133, 4133 onto both sides of the tape 100 in the dipping tank 411.

Draining Step:

The tape 100, after passing the post-cleaning means 4133, 4133, is transferred into the receiving section 421 of the air blow section 42, where it is sprayed with compressed air onto both sides of the tape 100 by two pairs of the air knives 422, 422.

Drying Step:

The tape 100 leaving the air knives 422, 422 is deflected to the right side (to the tape receiving means 5 side) by the fifth guide roller 49 and transferred in a horizontal direction through the hot-wind heater 43, where hot wind is blown through the ports 43b, onto both sides of the tape 100.

Receiving Step:

The tape 100 leaving the hot-wind heater 43 is sent to the tape winding reel 54 via the guide roller 57 for winding the tape. At the same time, the spacer tape supplying reel 53 rotates in the supplying direction C to send the spacer tape 102 to the tape winding reel 54 via the guide rollers 55 and 56, to be wound around the reel 54.

The tape winding reel 54 rotates in the winding direction D to wind the cleaned and dried tape 100, while setting thereon the spacer tape 102 sent from the spacer tape supplying reel 53.

Dust-Free Packing Step:

On completion of totally winding the tape 100 around the tape winding reel 54 together with the spacer tape 102, an operator releases the tape winding reel 54 from the rotation shaft 52 and carries it into the packing booth 24 (see FIG. 2) for packing.

As described above, in the cleaning of the tape 100, the tape 100 is dipped in the dipping water 411b in the dipping step before being cleaned to weaken adherence of foreign matter attached on the tape, because it swells or absorb water.

Therefore, the ultrasonic cleaning step can easily remove foreign matter from the tape 100 by the ultrasonic cleaning means 4132. This step treats the dipped tape 100 by the ultrasonic cleaning means 4132, unlike a conventional method, and can prevent redeposition of the removed foreign matter on the tape 100. Therefore, the tape cleaning device 1 and tape cleaning method of this embodiment can improve cleaning efficiency of the tape 100.

It is preferable to keep the second guide roller 46 and third guide roller 47, which are provided in the dipping tank 411 to dip the tape 100 being transferred, apart from each other at an adequate distance (110L, 300 to 2000 mm or so, refer to FIG. 3) to allow foreign matter attached on the tape 100 to sufficiently swell or absorb water in the dipping water 4116.

Moreover, the ultrasonic cleaning step supports the tape 100 at the spraying position 110a on the transferring line 110 by the fourth guide roller 48 to prevent it from being flattered while it is sprayed with a solution. This further facilitates removal of foreign matter from the tape 100 and hence improves cleaning efficiency of the tape 100.

It is preferable to keep the ultrasonic cleaning means 4132 apart from the tape 100 at an adequate distance, generally 1 to 50 mm, more preferably 10 to 30 mm, between the nozzle 4132a tip and wiring-patterned surface 100a of the tape 100.

A shorter distance between the nozzle 4132a tip and wiring-patterned surface 100a is not desirable, because an inner lead (terminal), when provided on the wiring-patterned surface 10a, may be deformed by a solution injection pressure at the nozzle 4132a. A longer distance between the tip of the nozzle 4132a and the wiring-patterned surface 100a is also undesirable, because a solution ejected from the nozzle 4132a may not sufficiently reach the wiring-patterned surface 100a to deteriorate cleaning efficiency.

Keeping the nozzle 4132a tip and wiring-patterned surface 100a apart from each other at the adequate distance described above can prevent deformation of an inner lead and, at the same time, prevent deterioration of cleaning efficiency. For example, deformation of an inner lead provided on a 3-layered tape with device holes can be prevented by keeping a distance between the nozzle 4132a tip and wiring-patterned surface 100a at 10 to 30 mm.

The pre-cleaning step upstream of the ultrasonic cleaning step sprays a solution by the pre-cleaning means 4131, 4131 onto the tape 100, to remove foreign matter attached on the tape 100 also in this step.

Therefore, the ultrasonic cleaning step should have a lower load for removing foreign matter attached on the tape 100 than a device having no pre-cleaning step. This further facilitates removal of foreign matter from the tape 100 and hence improves cleaning efficiency of the tape 100.

Moreover, the pre-cleaning step transfers the dipped tape 100 obliquely upwards. This provides a longer cleaning path 4131L for the pre-cleaning means 4131, 4131 than in a step which transfers the tape 100 in a horizontal direction, and allows the step to remove a larger quantity of foreign matter attached on the tape 100.

This can further reduce quantity of foreign matter on the tape 100 to be removed by the ultrasonic cleaning means, and hence facilitate removal of foreign matter attached on the tape 100 and improve tape cleaning efficiency of the tape 100.

The pre-cleaning step in this embodiment transfers the tape 100 upwards at a tilt angle α set at 45°. However, the tilt angle is not limited to 45°, so long as it is in a range preferably from 10 to 170°, more preferably 10 to 89° or 91 to 170°.

A tilt angle below 10 or above 170° is not desirable, because it may be difficult to secure positions at which the pre-cleaning means 4131, 4131 are set, and the tape cleaning path for the pre-cleaning means 4131, 4131 is essentially the same as the horizontal path and hence foreign matter removing efficiency is essentially unchanged.

At a tape tilt angle of 90°, on the other hand, the fourth guide roller 48 comes into contact with the tape 100 at a line, unlike the case of tilt angle set at 10 to 89° or 91 to 170°, and it is difficult for the fourth guide roller 48 to support the tape 100 on the transferring line 110 and hence to insufficiently exhibit its functions as the guide roller 48.

To securely keep a high cleaning efficiency, tilt angle 10 to 170 for tape 100 is preferred to assure longer pass for 4131L in the cleaning area where splashed cleaning solution flows downwards on the tape 100, when compared with horizontal pass of the tape 100.

Of the two guide rollers 47 and 48 for tilting the tape 100 for the tape cleaning device 1 of this embodiment, the guide roller 48 on the ultrasonic cleaning means 4132 side is structured to work also as supporting means for the present invention. This reduces number of device members to secure a longer cleaning path for the pre-cleaning means 4131, 4131 while preventing flatter of the tape 100 when it is sprayed with a solution by the ultrasonic cleaning means 4132. Therefore, the tape cleaning device 1 of this embodiment can improve tape 100 cleaning efficiency while reducing its production cost.

On the other hand, the tape 100 leaving the ultrasonic cleaning step is sprayed with a solution by the post-cleaning means 4133, 4133 in the post-cleaning step. This step can remove foreign matter even when it remains on the tape 100 treated by the ultrasonic cleaning step, or is attached on the tape 100 surface opposite to the wiring-patterned surface 100a of the tape 100 when the fourth guide roller 48 comes into contact with the surface. This can further improve tape 100 cleaning efficiency. When foreign matter deposited on the tape 100 can be removed in the ultrasonic cleaning step by itself to an extent not to cause deterioration of its quality, the post-cleaning step can be eliminated.

The tape 100 leaving the post-cleaning step is treated with compressed air blown onto the surface by the air knives 422, 422 in the draining step before being sent to the drying step. This blows off the solution from the tape 100 to reduce quantity of the solution to be removed in the drying step, and hence improves tape 100 production efficiency, because the drying step can be completed in a shorter time than that in a device having no draining step.

The tape cleaning device 1 of this embodiment also dries the cleaned tape 100 by the hot-wind heater 43, to produce the tape 100 in a shorter time than a device in which cleaning and drying of the tape 100 are separately conducted, and hence to further improve tape 100 production efficiency.

The hot-wind heater 43 preferably has a total length (along the tape 100 transferring direction A) of 500 to 3000 mm and heats air to a temperature level set at 60 to 140° C., to sufficiently evaporate a solution attached on the tape 100.

Moreover, this embodiment separates the spacer tape 101 from the tape 100 being transferred, and receives the cleaned and dried tape 100 while setting the another spacer tape 102 thereon. Therefore, it can smoothly perform separation of the spacer tape 101 from the tape 100 while preventing damages of the cleaned tape surface 10a (e.g., wiring pattern on the tape surface 100a), and hence improve production efficiency of the tape 100 product with a spacer tape set thereon.

This embodiment is provided with the dust-free packing booth 24, to prevent foreign matter from being attached on the cleaned and dried tape 100 while it is being packed, and hence to improve tape 100 quality.

### Second Embodiment

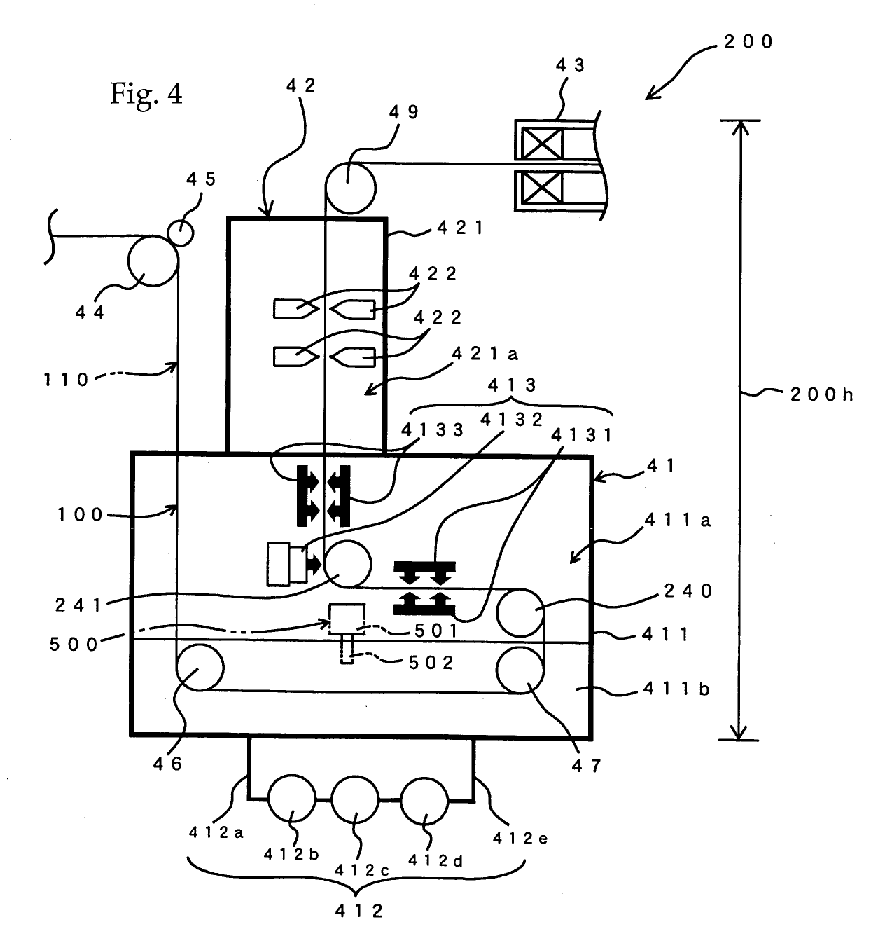

FIG. 4 schematically illustrates the essential portion of the tape cleaning device 200 as the second embodiment, where a device member for the same function as the one for the first embodiment is marked with the same symbol. Description of the second embodiment will be centered for different device members.

The tape cleaning device 200 of this embodiment comprises the three guide rollers 47, 240 and 241 for turning the tape 100 dipped in the dipping tank 411 in a horizontal direction. The pre-cleaning means 4131, 4131 are structured in such a way to clean the tape 100 deflected by these guide rollers 47, 240 and 241.

This structure can keep height of the tape 100 transferring region, more specifically height 200h of the tape cleaning device 200, lower than the height 1h in the tape cleaning device 1 of the first embodiment described above (refer to FIG. 3) as compared with the case where the tape after the immersion is carried upward. Therefore, the tape cleaning device 200 of this embodiment can have a reduced device setting space.

Moreover, the guide roller 241 on the ultrasonic cleaning means 4132 side is structured to work also as supporting means for the present invention to reduce number of device members. Therefore, the tape cleaning device 200 of this embodiment can improve tape 100 cleaning efficiency while reducing its production cost, as is the case with the tape cleaning device 1 of the first embodiment.

### Third Embodiment

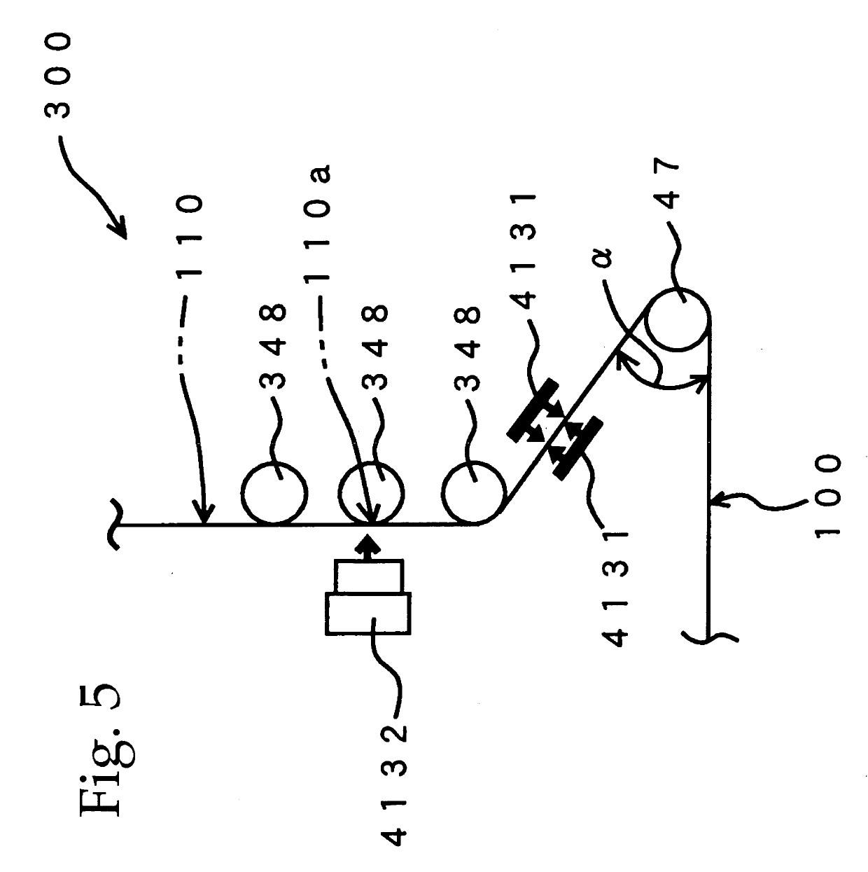

FIG. 5 schematically illustrates the essential portion of the tape cleaning device 300 as the third embodiment, where a device member for the same function as the one for the first embodiment is marked with the same symbol. Description of the third embodiment will be centered for different device members.

The tape cleaning device 300 of this embodiment comprises the three guide rollers 348 separately set in a vertical direction along the transferring line 100a.

This structure can secure a longer length of the tape 100 by means of the guide rollers, because it has more guide rollers than the structure of the first embodiment (guide roller 48) and the second embodiment (guide roller 241), and hence can support more stably the tape 100 on the transferring line 100a.

Therefore, the tape cleaning device 300 of this embodiment can securely prevent flatter of the tape 100 even when it is sprayed with an ultrasonically vibrating solution by the ultrasonic cleaning means 4132, and hence improve tape 100 cleaning efficiency.

Moreover, the guide roller 348 at the lowest position is structured in such a way to work as one of the two guiding means (i.e., as the one on the ultrasonic cleaning means 4132 side) which transfer the dipped tape 100 obliquely upwards. Therefore, the tape cleaning device 300 of this embodiment can have improved tape 100 cleaning efficiency while reducing its production cost, as is the case with the tape cleaning device of each embodiment described above.

### Fourth Embodiment

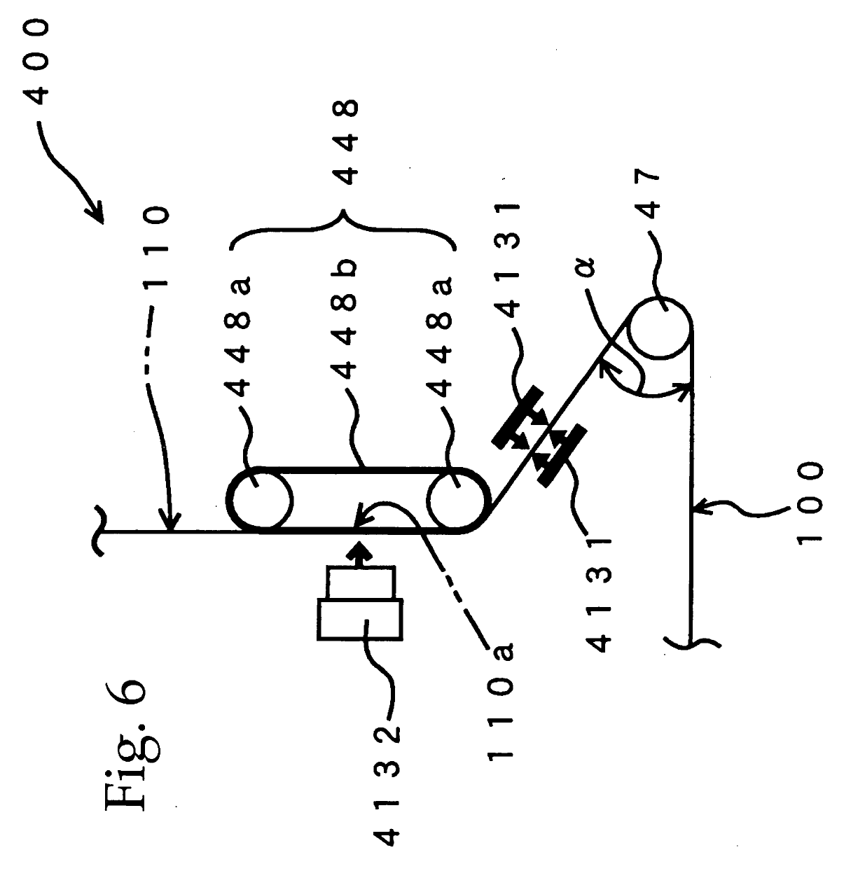

FIG. 6 schematically illustrates the essential portion of the tape cleaning device 400 as the fourth embodiment, where a device member for the same function as the one for the first embodiment is marked with the same symbol. Description of the fourth embodiment will be centered for different device members.

The tape cleaning device 400 of this embodiment has the supporting means 448 structured in a belt conveyor shape for the present invention, comprising a pair of the rollers 448a, 448a provided vertically apart along the transferring line 110 and a belt loop running over these rollers 448a, 448a.

The supporting means 448 of the above structure can secure a longer length and wider area for the means to be in contact with the tape 100 than the guide roller 48 for the first embodiment and guide roller 241 for the second embodiment, to stably support the tape 100 on the transferring line 110.

Therefore, the tape cleaning device 400 of this embodiment can securely prevent flatter of the tape 100 even when it is sprayed with a solution by the ultrasonic cleaning means 4132, and hence improve tape 100 cleaning efficiency.

Moreover, the supporting means 448 is structured in such a way to work as one of the two guiding means (i.e., as the one on the ultrasonic cleaning means 4132 side) which transfer the dipped tape 100 obliquely upwards. Therefore, the tape cleaning device 400 of this embodiment can have improved tape 100 cleaning efficiency while reducing its production cost, as is the case with the tape cleaning device of each embodiment described above.

These embodiments are described for the case of cleaning film carrier tapes for mounting electronic devices, e.g., TAB (Tape Automated Bonding), COF (Chip On Film), BGA (Ball Grid Array) and CSP (Chip Size Package) tapes. However, the present invention can be applied similar to spacer tapes described in these embodiments and sheet type FPC and the like. Moreover, the tape cleaning device can use different types of solution, different transferring, cleaning, draining and drying means structures, and different controlling methods among others, depending on tape type to be cleaned.

Moreover, these embodiments are described for the case where one tape cleaning device 1 is set in the clean booth 2. However, number of the tape cleaning device 1 is not limited to the above. For example, the plurality of tape cleaning devices 1 may be set in a line in the clean booth 2. Moreover, the ultrasonic cleaning means 4132 is set over the dipping water 411b in these embodiments. However, in addition to the ultrasonic cleaning means 4132, another ultrasonic cleaning means 500 (illustrated in the area surrounded by broken lines with two dots between the lines) or equivalent of the ultrasonic cleaning means 4132 may have a nozzle immersed in the dipping water 411b.

The present invention is described in detail by Examples and Comparative Example. However, it is to be understood that the present invention is not limited to Examples.

### EXAMPLE 1

Cleaning of the Tape 100

The tape cleaning device 1 of the first embodiment was used, where the pre-cleaning means 4131, 4131 were omitted to distinguish its effects from those of the device of Comparative Example. Type of the tape 100 and conditions under which the tape cleaning device 1 used in this example was operated are described below.

(1) tape 100 to be cleaned: A two-layered film carrier tape, comprising a 38 μm thick polyimide base film tape layer and 8 μm thick copper layer, for COFs was used.

(2) Transferring means: Transferring rate was set at 3 m/minute.

(3) Dipping tank 411: Pure water kept at 25° C. was used.

(4) Ultrasonic cleaning means 4132: A means of KAIJO CORP. (ultrasonic transmitter: 68101, vibrator plate: 6879BK) was used, where frequency, water flow rate and injection pressure were set at 950 kHz, 25 L/minute and 0.2 MPa, respectively.

(5) Post-cleaning means 4133, 4133: Water flow rate and injection pressure were set at 4 L/minute and 0.2 MPa, respectively.

(6) Hot-wind heater 43: A heater having a total length of 2000 mm was used, where heated air was controlled at 100±5° C.

Measurement of Number of Foreign Matter Remaining on the Cleaned Tape 100:

The tape 100 was observed by a stereo microscope (optical microscope) at a magnification of 10 to count number of foreign matter having a size of 50 μm or more, attached on the outermost surface of the tape 100, wound around the tape winding reel 54 immediately before shipment.

### EXAMPLE 2

Cleaning of the Tape 100:

The tape cleaning device 200 of the second embodiment was used, and operated under the same conditions as those for Example 1.

Measurement of Number of Foreign Matter Remaining on the Cleaned Tape 100:

Number of foreign matter was counted in the same manner as in Example 1.

### EXAMPLE 3

Cleaning of the Tape 100:

The ultrasonic cleaning means 500 of KAIJO CORP. (vibrator plate 501: 6281A, illustrated in the area surrounded by broken lines with two dots between the lines) was used, as illustrated in FIG. 4. More specifically, the ultrasonic cleaning means 500 was used for the tape cleaning device 200 of the second embodiment, where it had the nozzle 502 dipped in the dipping water 411b in such a way that it faced the tape 100 running below in the dipping water 411b. It was operated under the same conditions as those for Example 2.

Measurement of Number of Foreign Matter Remaining on the Cleaned Tape 100:

Number of foreign matter was counted in the same manner as in Example 1.

### COMPARATIVE EXAMPLE

Cleaning of the Tape 100:

The same ultrasonic cleaning means 500 as that of Example 3 was used for the tape cleaning device disclosed in Patent Document 1.

Measurement of Number of Foreign Matter Remaining on the Cleaned Tape 100:

Number of foreign matter was counted in the same manner as in Example 1.

<Comparison of the Results Between Examples and Comparative Example>

Table 1 shows the counts of foreign matter attached on the tapes 100 cleaned in Examples and Comparative Example, where each count is average number of foreign matter per 1 meter. In the table, “white,” “black,” “filamentous” and “metallic” denote foreign matter of plastic-based organic substance considered to come from the tape 100 or reels, inorganic foreign matter considered to come from an electroconductive coating component of the spacer tape 102, filamentous foreign matter considered to come from dust-proof clothes worn by operators, and foreign matter of iron, aluminum or the like considered to come from facilities used for production or examination, respectively.

TABLE 1

| | | Treating | Number of foreign matter attached on the outermost | | | | | |
|---|---|---|---|---|---|---|---|---|
| | | rate | tape surface (average number per 1 m) | | | | | |
| | Lot number | (m/min) | Total | White | Black | Filamentous | Metallic | Others |
| Ex. 1 | 20 | 3 | 2.1 | 1.5 | 0.5 | 0.0 | 0.1 | 0.0 |
| Ex. 2 | 20 | 3 | 2.9 | 1.5 | 0.7 | 0.3 | 0.1 | 0.3 |
| Ex. 3 | 20 | 3 | 1.9 | 1.4 | 0.4 | 0.0 | 0.1 | 0.0 |
| Com. | 20 | 3 | 15.6 | 7.2 | 3.8 | 2.3 | 0.5 | 1.8 |
| ex. 4 | | | | | | | | |

It is apparent, as shown in Table 1, that each of the tape cleaning devices of the present invention has a higher capacity for removing foreign matter attach ed on the tape 100 than the conventional one.

### INDUSTRIAL APPLICABILITY

As described above, the tape cleaning device and tape cleaning method of the present invention are sufficiently applicable to the related industrial area, because of high tape cleaning efficiency which they secure.

1. A tape cleaning device, comprising:
a tape transferring means for transferring a tape,
a dipping tank holding a solution in which the tape being transferred is dipped, and
ultrasonic cleaning means for removing foreign matter attached to the tape by spraying an ultrasonically vibrating solution onto the tape after the tape is dipped in the tank.

2. The tape cleaning device according to claim 1, wherein the tape transferring means comprises supporting means on a transferring line for supporting the tape at a position at which a solution is sprayed onto the material by the ultrasonic cleaning means.

3. The tape cleaning device according to claim 1, further comprising a pre-cleaning means for removing foreign matter attached to the tape after the tape is dipped in the tank and before the tape is cleaned by the ultrasonic cleaning means.

4. The tape cleaning device according to claim 3, wherein the tape transferring means comprises a plurality of guiding means for guiding the tape upwards after the tape is dipped in the tank, and wherein the pre-cleaning means is structured in such a way so as to remove foreign matter attached to the tape guided upwards by the plurality of guiding means.

5. The tape cleaning device according to claim 4, wherein the tape is set at a tilt angle of 10 to 170° while the tape is being guided upwards by the plurality of guiding means.

6. The tape cleaning device according to claim 3, wherein the tape transferring means comprises a plurality of guiding means for guiding the tape in a horizontal direction after the tape is dipped in the tank, and wherein the pre-cleaning means is structured in such a way to remove foreign matter attached to the tape guided in a horizontal direction by the plurality of guiding means.

7. The tape cleaning device according to claim 4, wherein the tape transferring means is structured in such a way that some of the guiding means on the side of the ultrasonic cleaning means work also as the supporting means and, at the same time, the ultrasonic cleaning means is configured so that the solution is sprayed onto the tape supported on the transferring line by the guiding means.

8. The tape cleaning device according to claim 1, further comprising post-cleaning means for removing foreign matter attached to the tape after the tape is cleaned by the ultrasonic cleaning means.

9. The tape cleaning device according to claim 1, further comprising drying means for drying the tape after the tape is cleaned by the ultrasonic cleaning means or post-cleaning means.

10. The tape cleaning device according to claim 9, further comprising draining means upstream of the drying means for removing the solution from the cleaned tape.

11. The tape cleaning device according to claim 9 which cleans the tape on which a spacer tape is set, wherein
the tape transferring means comprises
tape supplying means for sending the tape to the transferring line while separating the spacer tape from the tape and
tape receiving means for receiving the tape cleaned and dried by the drying means while setting another spacer tape thereon.

12. The tape cleaning device according to claim 11, further comprising a dust-free packing chamber for packing, in a dust-free condition, the cleaned tape contained in the tape receiving means.

13. The tape cleaning device according to claim 1, which cleans the tape to remove foreign matter attached thereon, wherein the tape is used as a film carrier tape for mounting electronic devices.

14. A tape cleaning method for cleaning a tape being transferred, comprising:
a dipping step for dipping the tape, and
an ultrasonic cleaning step for removing foreign matter attached to the dipped tape by spraying an ultrasonically vibrating solution onto the dipped tape.

15. The tape cleaning method according to claim 14, wherein the ultrasonic cleaning step sprays the solution onto the tape supported on a transferring line at a spraying position.

16. The tape cleaning method according to claim 14, further comprising a pre-cleaning step upstream of the ultrasonic cleaning step for removing foreign matter attached to the dipped tape.

17. The tape cleaning method according to claim 16, wherein the dipped tape is transferred upwards in the pre-cleaning step.

18. The tape cleaning method according to claim 17, wherein the tape is set at a tilt angle of 10 to 170° while the tape is being transferred upwards in the pre-cleaning step.

19. The tape cleaning method according to claim 16, wherein the dipped tape is transferred in a horizontal direction in the pre-cleaning step.

20. The tape cleaning method according to claim 14, further comprising a post-cleaning step downstream of the ultrasonic cleaning step for removing foreign matter attached to the tape.

21. The tape cleaning method according to claim 14, further comprising a drying step downstream of the ultrasonic cleaning step for drying the cleaned tape.

22. The tape cleaning method according to claim 21, further comprising a draining step upstream of the drying step for removing the solution from the cleaned tape.

23. The tape cleaning method according to claim 21 which cleans the tape on which a spacer tape is set, comprising:
a tape supplying step upstream of the dipping step for sending the tape to the transferring line while separating the spacer tape from the tape and
a tape receiving step downstream of the drying step for receiving the cleaned and dried tape while setting another spacer tape thereon.

24. The tape cleaning method according to claim 23, further comprising a dust-free packing step downstream of the tape receiving step for packing, in a dust-free condition, the received tape.

25. The tape cleaning method according to claim 14, which cleans the tape to remove foreign matter attached thereon, wherein the tape is used as a film carrier tape for mounting electronic devices.
